(19) United States
(12) Patent Application Publication
(10) Pub. No.: US 2017/0060850 A1
(43) Pub. Date: Mar. 2, 2017

(54) PERSONAL TRANSLATOR

(71) Applicant: Microsoft Technology Licensing, LLC, Redmond, WA (US)

(72) Inventors: William Lewis, Seattle, WA (US); Arul Menezes, Bellevue, WA (US); Matthai Philipose, Seattle, WA (US); Vishal Chowdhary, Kirkland, WA (US); John Franciscus Marie Helmes, Steijl (NL); Stephen Hodges, Cambridge (GB); Stuart Alastair Taylor, Cambridge (GB)

(21) Appl. No.: 14/834,197

(22) Filed: Aug. 24, 2015

(51) Int. Cl. G06F 17/28; G10L 13/00; G10L 15/24; G10L 15/30

(52) U.S. Cl. CPC G06F 17/289; G06F 17/2836; G10L 15/30; G10L 13/00; G10L 15/24

(57) ABSTRACT

The personal translator implementations described herein provide a speech translation device that pairs with a computing device to translate in-person conversations. The speech translation device can be wearable. In one implementation the personal translator comprises a speech translation device with at least one microphone that captures input signals representing nearby speech of a first user/wearer of the device and at least one other nearby person in a conversation in two languages; a wireless communication unit that sends the captured input signals representing speech to a nearby computing device, and receives for each language in the conversation, language translations from the computing device; and at least one loudspeaker that outputs the language translations to the first user/wearer and at least one other nearby person. The language translations in text form can be displayed on a display at the same time the language translations are output to the loudspeaker(s).

### BACKGROUND

Because travel to foreign countries has become ubiquitous due to more efficient means of travel over the years, more and more people find themselves in the position of trying to communicate with someone that does not speak their language. For example, a simple task of hiring a taxi at an international airport, finding the nearest subway station or asking directions to a hotel or a landmark is difficult if two people do not speak each other's language.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In general, the personal translator implementations described herein comprise a speech translation device that is used to translate in-person conversations between at least two people in a conversation in at least two languages. In some implementations the speech translation device is wearable and in other implementations the speech translation device is not wearable or worn. The speech translation device pairs with a nearby computing device to send in-person speech and receive real-time translations for the speech.

In one implementation the personal translator comprises a wearable speech translation device with a microphone that captures input signals representing speech of a wearer of the wearable speech translation device and at least one other nearby person. The wearable speech translation device of the personal translator also has a wireless communication capability that sends the captured input signals representing speech to a nearby computing device, and receives language translations from the computing device. The wearable speech translation device of the personal translator also has a speaker that outputs the language translations to the wearer and at least one other nearby person so that the wearer and the nearby speech can hear both the speech in the original language and the translations output by the speaker.

In another personal translator implementation, the personal translator comprises a system that includes a speech translation device (that can be wearable or not wearable) and a computing device. The computing device receives from the nearby speech translation device input signals representing speech of a first user of the speech translation device and at least one other nearby person in a conversation conducted in two different languages.

For each language of the conversation, the computing device automatically creates language translations of the input speech signals and sends these language translations to the nearby speech translation device. In one implementation the translations are created by detecting the language spoken by using a speech recognizer for both languages in the conversation. The speech recognizer attempts to recognize the speech in both languages of the conversation at the same time and passes the recognition result with the highest score to a speech translator for translation into the opposing language. The translator translates the received speech into the opposing language and generates a transcript of the translated speech (e.g., a text translation). The transcript/text translation is output to a loudspeaker of the speech translation device using a text-to-speech converter. The transcripts/text translations in some personal translator implementations are displayed at the same time that the loudspeaker outputs the translated speech (e.g., on a display of the computing device or some other display, such as, for example, a display used in a virtual reality/augmented reality environment). In some implementations the loudspeaker includes a resonant chamber in order to output the language translations sufficiently loud enough so that the first user and nearby conversation participants can hear the translations.

The personal translator implementations described herein are advantageous in that they provide a small, easily transportable speech translation device which provides for hands-free in-person language translation. In some implementations, the speech translation device is small, light and inexpensive because it performs minimal complex processing and therefore requires few complex and expensive components. The speech translation device can be a wearable speech translation device that is worn by a user and hence can be always easily accessible. Furthermore, the speech translation device can be wirelessly paired with various computers that can provide translation services so the user does not have to carry a computing device with them constantly. It translates bilingually in in-person scenarios in real-time. A conversational translation allows for flowing conversations, rather than an utterance-at-a-time translation. In some implementations, the speech translation device is always on, and is activated by touch, gesture and/or voice cue. The personal translator detects the language being spoken and automatically translates the received signal to the correct language. In some implementations the speech translation device of the personal translator can be moved relative to the computing device paired to it in order to better capture the in-person speech of all participants in a conversation.

### DESCRIPTION OF THE DRAWINGS

The specific features, aspects, and advantages of the disclosure will become better understood with regard to the following description, appended claims, and accompanying drawings where:

FIG. 1 is an exemplary environment in which personal translator embodiments can be practiced.

FIG. 2 is a functional block diagram of an exemplary speech translation device of a personal translator implementation as described herein.

FIG. 3 is a functional block diagram of an exemplary personal translator implementation as described herein.

FIG. 4 is functional block diagram of another exemplary personal translator implementation that has the ability to display transcripts of the translated speech as described herein.

FIG. 5 is functional block diagram of another exemplary personal translator implementation that employs one or more servers or a computing cloud to perform speech recognition and/or translations.

FIG. 6 is a functional block diagram of another exemplary personal translator implementation that incorporates a computing device.

FIG. 7 is an exemplary block diagram of an exemplary process for practicing various exemplary personal translator implementations.

FIG. 8 is an exemplary computing system that can be used to practice exemplary personal translator implementations described herein.

### DETAILED DESCRIPTION

In the following description of personal translator implementations, reference is made to the accompanying drawings, which form a part thereof, and which show by way of illustration examples by which implementations described herein may be practiced. It is to be understood that other embodiments may be utilized and structural changes may be made without departing from the scope of the claimed subject matter.

### 1.0 Personal Translator Implementations

The following sections provide an overview of the personal translator implementations described herein, as well as exemplary systems for practicing these implementations.

As a preliminary matter, some of the figures that follow describe concepts in the context of one or more structural components, variously referred to as functionality, modules, features, elements, etc. The various components shown in the figures can be implemented in any manner. In one case, the illustrated separation of various components in the figures into distinct units may reflect the use of corresponding distinct components in an actual implementation. Alternatively, or in addition, any single component illustrated in the figures may be implemented by plural actual components. Alternatively, or in addition, the depiction of any two or more separate components in the figures may reflect different functions performed by a single actual component.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner.

1.1 Overview

In general, the personal translator implementations described herein include a speech translation device that pairs with a computing device to provide for in-person translations between at least two people in a conversation conducted in at least two languages.

The personal translator implementations described herein are advantageous in that they provide a speech translation device that can be wearable and which provides for hands-free in-person language translation. The speech translation device is small, light and inexpensive because it pairs with a nearby computing device and hence performs minimal complex processing itself and therefore requires few complex and expensive components. As a result, it is easily transportable and in a wearable configuration can be worn for long periods of time without discomfort to a wearer. The speech translation device translates bilingually (e.g., English to/from Chinese) in in-person scenarios (e.g., in taxi cab, at a store counter, etc.) in real-time. A conversational translation allows for flowing conversations, rather than an utterance-at-a-time translation. In some implementations, the speech translation device is always on, and is activated by single touch and/or voice cue. The personal translator detects the language being spoken and automatically translates the received speech to the opposing language in the conversation. For example, when worn or used by an English speaker in France, it will translate any detected French to English and any detected English to French. This allows for bi- to multi-lingual scenarios between two or more participants. In some personal translator implementations the translations are displayed at the same time a transcript of the translated speech is output by a loudspeaker of the speech translation device. This implementation is particularly beneficial for allowing deaf or hearing impaired persons to participate in a conversation (either in the same language or in a bi-lingual conversation). In some implementations the loudspeaker has a resonant chamber which allows for increased volume of the translated speech with minimal energy consumption.

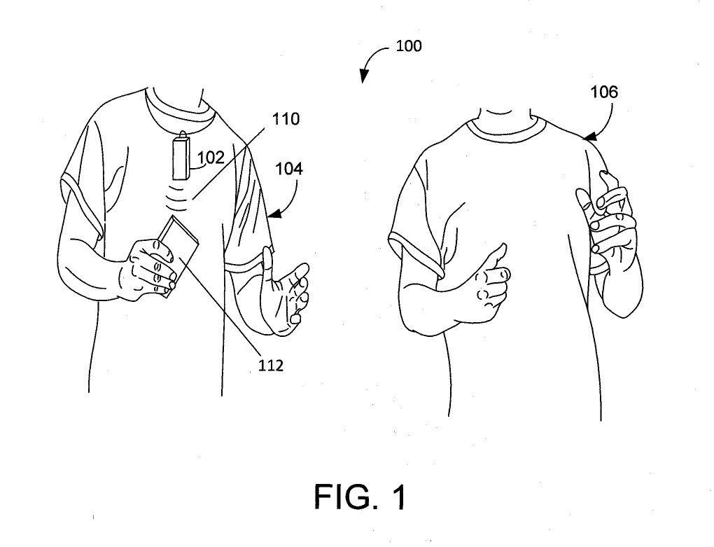

FIG. 1 depicts an exemplary environment 100 for practicing various personal translator implementations as described herein. As shown in FIG. 1, this personal translator embodiment 100 includes a wearable speech translation device 102 that is worn by a user/wearer 104 and a nearby computing device 112. The nearby computing device 112 can be held by the user/wearer 104 but can equally well be stored in the user's/wearer's pocket or can be elsewhere in proximity to the wearable speech translation device. The wearable speech translation device 102 includes a microphone (not shown) that captures input signals representing nearby speech of the user/wearer 104 of the device and at least one other nearby person 106. The wearable speech translation device 102 also includes a wireless communication unit 110 that sends the captured input signals representing speech to the nearby computing device 112. The nearby computing device 112 can be, for example, a mobile phone, a tablet computer or some other computing device, or even a computer in a virtual reality or augmented reality environment. In some personal translator embodiments the wearable speech translation device 102 communicates with the nearby computing device via Bluetooth or other near field communication (NFC) or wireless communication capability.

The wearable speech translation device 102 receives language translations of the input signals for two languages in a conversation (the language spoken by the first user/wearer and another language spoken by the other nearby person(s) in conversation with the first user/wearer) from the computing device 112 over the wireless communication unit 110. The wearable speech translation device 102 also includes a loudspeaker (not shown) that outputs the language translations to the first user/wearer 104 and the at least one other nearby person 106. In some embodiments the loudspeaker includes a resonant chamber so that the translations can be output with sufficient loudness so that both the first user/wearer 104 and the nearby person 106 that is a party to the conversation can hear not only the original speech but also the translations. In some implementations there can be one or more directional speakers that can direct audio towards the wearer and the nearby person. In other implementations, a speaker array can be used to beamform either in one direction or another based on which directions the first and second users are expected to be relative to the device 102. It should be noted that in some personal translator embodiments a speech translation device that is not wearable or worn is paired with a computing device that performs the translation processing. For example, such a speech translation device can be clipped to a steering wheel of a car and paired with the computing device of the car. Or the speech translation device can be clipped to a laptop computer or tablet computing device or can be fabricated to be an integral part of such a device, such as, for example a kickstand. The speech translation device can also be outfitted with a magnetic clip that allows it to be attached to a surface conducive to best capturing the in-person conversation of the participants of the conversation. In some implementations, the speech translation device can be embedded in a remote control of a computing device. Or the speech translation device can be attached to, or in the vicinity of, a display to allow for text translations of speech received in a given language to be displayed to a user. In one implementation, the device can be put on a table between two or more people in a conversation. Many non-wearable configurations of the speech translation device can be envisioned.

1.2 Exemplary Implementations.

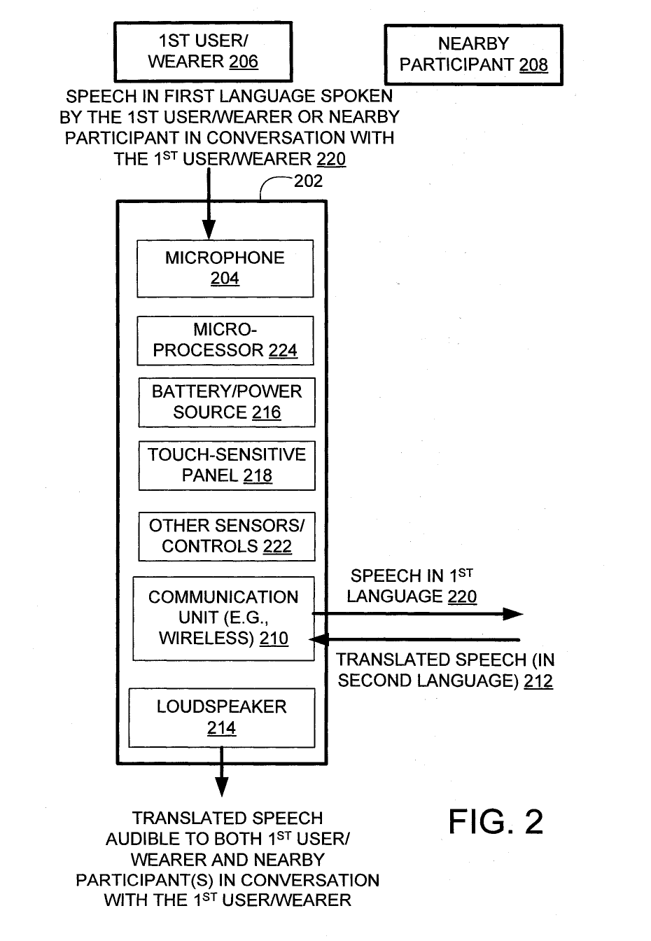

FIG. 2 depicts a speech translation device 202 that is employed with a personal translator for practicing various personal translator implementations as described herein. As shown in FIG. 2, this speech translation device 202 includes a microphone (or a microphone array) 204 that captures speech signals 220 of a first user 206 (or wearer if the speech translation device is worn) of the speech translation device 220 and a nearby participant 208 in a conversation with the first user/wearer. In some implementations, in the case of a microphone array, the microphone array can be used for sound source location (SSL) of the participants 206, 208 in the conversation or to reduce input noise. Also sound source separation can be used to help to identify which participant 206, 208 in the conversation is speaking.

The speech translation device 202 also includes a (e.g., wireless) communication unit 210 that sends the captured input signals 220 representing speech to a nearby computing device (not shown), and receives language translations 212 of the input signals from the computing device. The speech translation device 202 also includes a loudspeaker 214 (or more than one loudspeaker) that outputs the language translations 212 to be audible to the first user/wearer 206 and at least one other nearby participant 208 in the conversation. The speech translation device 202 further includes means 216 to charge the device (e.g., a battery, a rechargeable battery, equipment to inductively charge the device, etc.) It can also include a touch-sensitive panel 218 which can be used to control various aspects of the device 202. The speech translation device 202 can also have other sensors, actuators and control mechanisms 222 which can be used for various purposes such as detecting the orientation or location of the device, sensing gestures, and so forth. The speech translation device 202 also can have a micro-processor 224 that performs the processing for various functional aspects of the device such as encoding and decoding audio signals, processing touch or other control signals, processing communications signals and so forth.

In some implementations the speech translation device is worn by the first user/wearer. It can be worn in the form of a necklace (as shown in FIG. 1). In other implementations the speech translation device is a wearable speech translation device is in the form of a watch or a wristband. In yet other implementations, the speech translation device is in the form of a lapel pin, a badge or name tag holder, a hair piece, a brooch, and so forth. Many types of wearable configurations are possible.

Additionally, as discussed above, some personal translator embodiments employ a speech translation device that is not wearable. These speech translation devices have the same functionality of wearable speech translation devices described herein but have a different form. For example, they may have a magnet or a clip or another means of affixing the speech translation device in the nearby vicinity of a computing device that performs the translation processing for an in-person conversation or communicates with another computing device (e.g., a server, a computing cloud) that performs the translation processing.

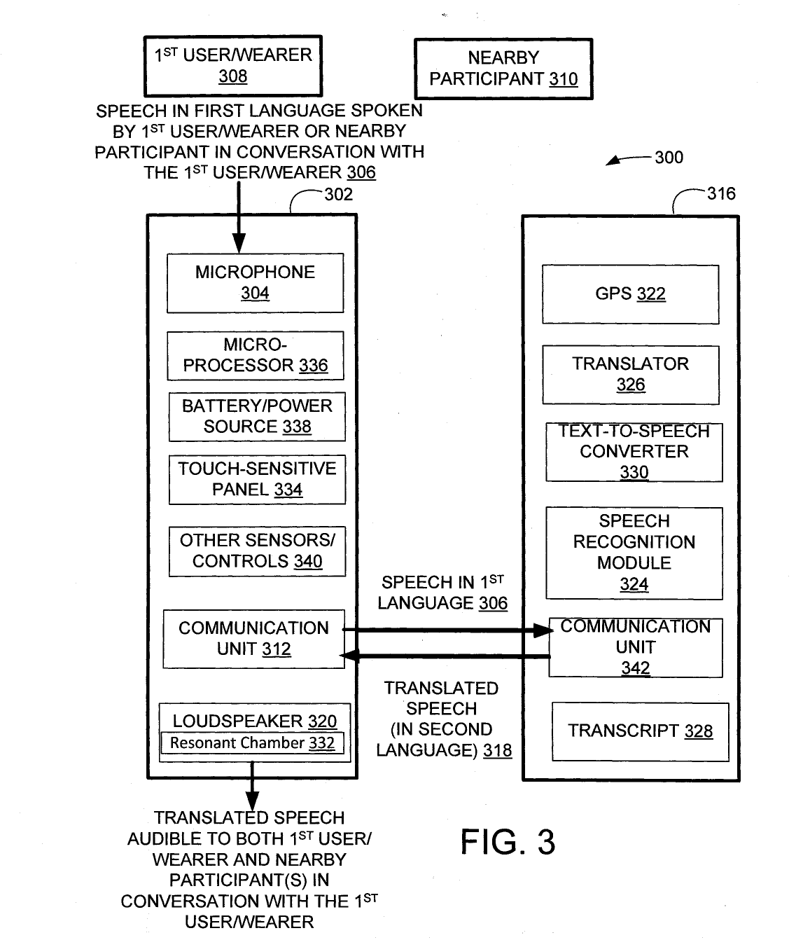

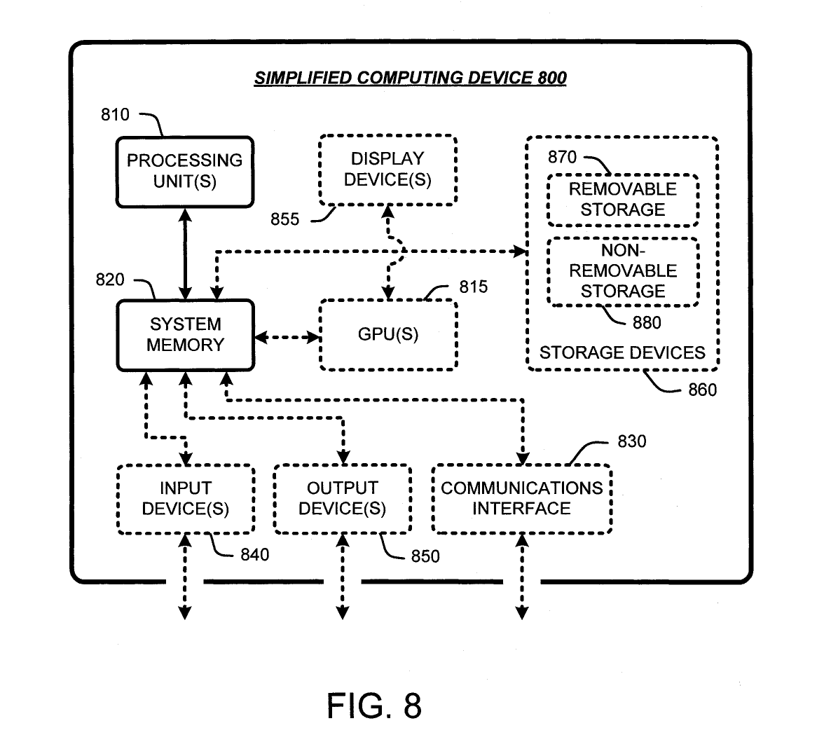

FIG. 3 depicts an exemplary personal translator 300 for practicing various personal translator implementations as described herein. As shown in FIG. 3, this personal translator 300 includes a speech translation device 302 and a computing device 316 (such as one that will be described in greater detail with respect to FIG. 8) that is in close proximity to the speech translation device 302 so as to be in wireless communication and/or paired with it. Similar to the speech translation device 202 discussed with respect to FIG. 2, the speech translation device 302 includes a microphone (or microphone array) 304 that captures input signals 306 representing nearby speech of a first user (or wearer if the speech translation device is worn) 308 of the device and at least one other nearby person 310. The speech translation device 302 also includes a wireless communication unit 312 that sends the captured input signals 306 representing speech to a nearby computing device 316, and receives language translations 318 of the input signals for two languages from the computing device. The speech translation device 302 also includes at least one loudspeaker 320 that outputs the language translations 318 so that they are audible to the first user/wearer 308 and the at least one other nearby person 310 that are having a conversation in two different languages. In some implementations the loudspeaker 320 includes a resonant chamber 332 so that the output speech/sound is loud enough for both participants 308, 310 in the conversation to hear. The resonant chamber 332 of the loudspeaker 320 is advantageous in that it significantly increases the volume output by the loudspeaker with minimal energy usage. It should be noted that the resonant chamber 332 does not necessarily need to be a separate chambers, as long as it is acoustically sealed. For example, the resonant chamber 322 can be the same chamber/area holding (some) electronics employed in the device. The speech translation device 302 also can have a micro-processor 336, a power source 338, a touch-sensitive panel 334 and other sensors, actuators and controls 340 which function similarly to those discussed with respect to FIG. 2.

In some implementations, the computing device 316 that interfaces with the speech translation device 302 can determine a geographic location of the computing device 316 and use this location information to determine at least one language of the conversation to be translated. For example, the computing device 316 can have a Global Positioning System (GPS) 322 that allows it to determine its location and use the determined location to infer one or both of the languages to be translated (e.g., it might infer that one language of a conversation between the first user/wearer of the device and another person located nearby is Chinese if the location is determined to be in China). In some implementations, the geographic location can be computed by using the location of cell phone tower IDs, WiFi Service Set Identifiers (SSIDs) or Bluetooth Low Energy (BLE) nodes. In some implementations, however, one or more languages of the conversation can be determined based on a user profile (e.g., of the first user/wearer) or can be input into the computing device or selected from a menu of choices on a display of the computing device (e.g., by a user). In some implementations the speech translation device can have a GPS or can use other methods to determine its geographic location (and hence the location of the conversation). In some implementations, the computing device detects the language being spoken by determining the geographic location of the computing device and using a lookup of probabilities of language for different regions of the world.

In one implementation of the speech translation device 302, communicates with the computing device 316 via a communication unit 342 on the computing device 316. A speech recognition module 324 on the computing device 316 scores the input speech for the likelihood that it represents a given language.

A speech recognizer 324 on the computing device 316 is run for both languages in the conversation. The speech recognizer 324 can determine which language is being spoken by extracting features from the speech signals and using speech models for each language to determine the probability of which language is being spoken. The speech models are trained with similar features as those extracted from the speech signals. In some implementations the speech models may be trained by the voice of the first user/owner of the speech translation device 302 and this information can be used to help determine one of the languages being spoken. The speech recognition module 324 passes the input speech with the highest score to a translator 326 for translation into the opposing (e.g. second) language of the conversation.

In one implementation, the translator 326 translates the input speech in the first language into the second language. This can be done, for example, by using a dictionary to determine possible translation candidates for each word or phoneme in the received speech and using machine learning to pick the best translation candidates for a given input. In one implementation, the translator 326 generates a translated transcript 328 (e.g., translated text) of the input speech, and the translated text/transcript 328 is converted to an output speech signal by using a text-to-speech converter 330. In some implementations the translator removes disfluencies from the input speech so that the translated speech 318 sounds more fluent (as opposed to one utterance at a time). The translated speech 318 is output by the loudspeaker (or loudspeakers) 320 so that both the first user/wearer 308 and at least another nearby person 310 can hear the translation 318.

In some implementations, the speech translation device 302 is always on and can be activated by a voice command. In some implementations the speech translation device 302 is activated by a touch command using a touch-sensitive panel 334. In these implementations the touch command can be received by a touch sensitive panel 334 on the device itself. However, many other methods can be used to activate the device, such as, for example by a simple tactile button/switch on the device, specific gesture of the first user/wearer, by voice command, by shaking the device or gripping it in a certain pre-defined manner, and so forth, depending on what other sensors 340 the speech translation device is configured with.

The personal translator can translate between more than two participants and/or in more than two languages in some implementations. In a case where there are more than two people in a conversation and more than two languages, different speech recognition models can be used to recognize the speech for each language spoken (and possibly each person speaking). There may also be multiple loudspeakers and multi-directional microphones. In such a case there may be multiple translations output for any given input speech, or the personal translator can be configured to translate all the received speech into one chosen language. Furthermore, people can sometimes understand a language better than they can speak it, so in some implementations one person may speak with no translations, but the replies to his speech are translated for him.

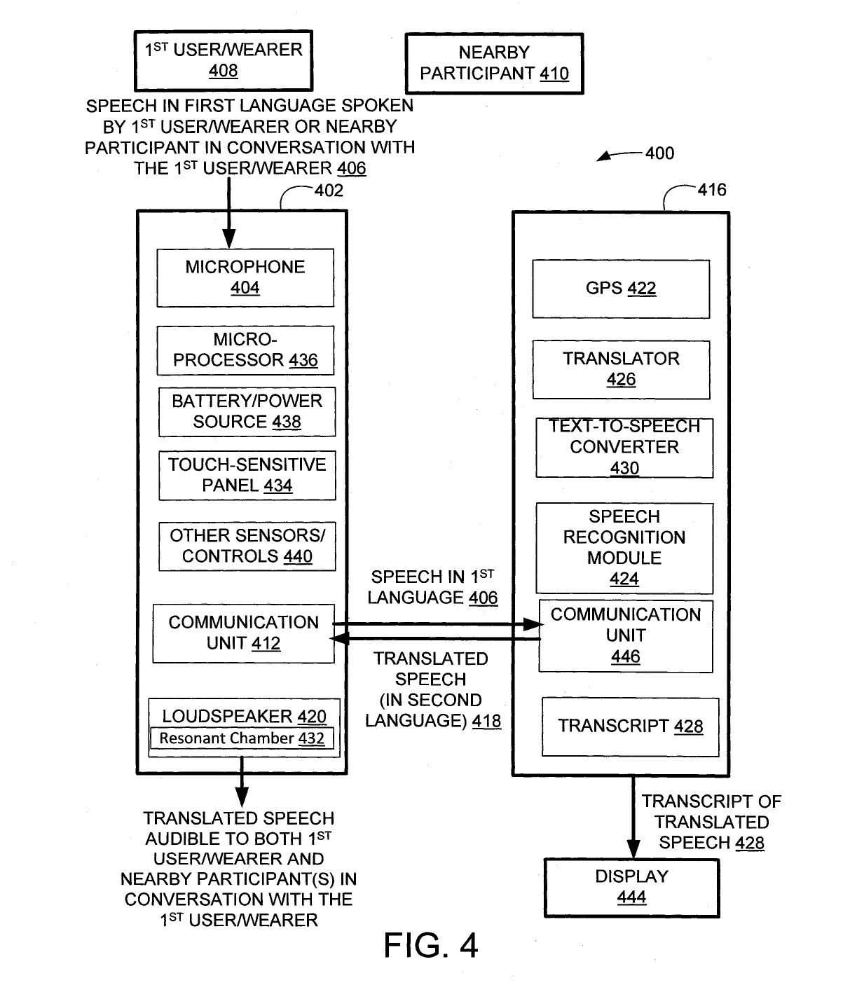

FIG. 4 depicts an exemplary personal translator 400 for practicing various personal translator implementations as described herein. As shown in FIG. 4, this personal translator 400 includes a speech translation device 402 (which may be a wearable or not wearable) and a nearby computing device 416 (such as one that will be described in greater detail with respect to FIG. 8). The speech translation device 402 includes at least one microphone 404 that captures input signals 406 representing nearby speech of a first user (or wearer if the speech translation device is worn) 408 of the device and at least one other nearby person 410. The speech translation device 402 also includes a wireless communication unit 412 that sends the captured input signals 406 representing speech to a nearby computing device 416, and receives language translations 418 of the input speech from the computing device. The speech translation device 402 also includes a loudspeaker 420 that outputs the language translations 418 to the first user/wearer 408 and the at least one other nearby person 410. As discussed previously with respect to FIGS. 2 and 3, the speech translation device 402 further can include a micro-processor 436, a power source 438, a touch-sensitive panel 434 and other sensors and controls 440.

Similar to the implementation shown in FIG. 3, the computing device 416 that interfaces with the speech translation device 402 can determine a geographic location of the computing device 416 and use this location information to determine one language of the conversation to be translated. For example, the computing device 416 can have a Global Positioning System (GPS) 422 that allows it to determine its location and use the determined location to infer one or both of the languages to be translated. Alternately, or in addition, in some implementations the speech translation device 402 might have a GPS or other method of determining location (not shown).

The speech translation device 402, communicates with the computing device 416 that runs a speech recognizer 424 for both of the two languages of the conversation. The speech recognizer 424 attempts to recognize the speech in both languages of the conversation at the same time and passes the recognition result with the highest score to a speech translator 426 for translation into the opposing language.

The translator 426 translates the input speech into the opposing language as discussed previously and generates a text translation (e.g., a transcript 428). The text translation/transcript 428 is converted to an output speech signal by using a text-to-speech converter 430. The translated speech 418 is output by the loudspeaker 420 so that both the first user/wearer 408 of the speech translation device 402 and at least another nearby person 410 can hear the translated speech 418.

In one implementation the translated text/transcript 428 of the input speech is displayed on a display 444 of the computing device 416 (or some other display (not shown)). In one implementation the translated text/transcript 428 is displayed at the same time the translated speech 418 is output by the loudspeaker 420. This implementation is particularly beneficial for the hard of hearing or deaf participants in the conversation because they can read the transcript and participate in the conversation even if they cannot hear the speech output through the loudspeaker.

In some implementations, as discussed above, the speech translation device 402 is always on and can be activated by a voice command. In some implementations the speech translation device 402 is activated by a touch command using a touch-sensitive panel 434. In these implementations the touch command can be received by a touch sensitive panel 434 on the device itself. However, many other ways can be used to activate the device, such as, for example by a specific gesture of the wearer, by voice command, by shaking the device or gripping it in a certain pre-defined manner, and so forth, depending on what other sensors 436 the speech translation device is configured with.

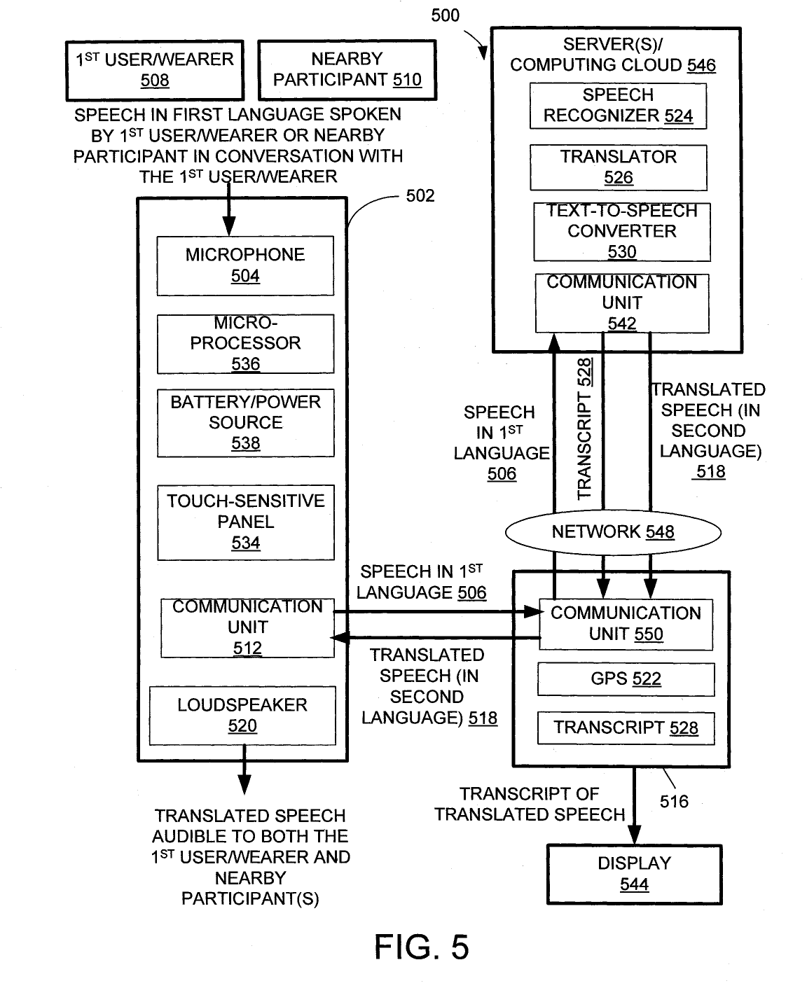

Yet another personal speech translator implementation 500 is shown in FIG. 5. As shown in FIG. 5, this personal translator 500 includes a speech translation device 502 which may be wearable or non-wearable, a computing device 516 nearby the speech translation device 502 and a server or computing cloud 546 that receives information from the computing device 516 and sends information to the computing device 516 via a network 548 and communication capabilities 542 and 550 on the devices 546, 516. The computing device 516 receives/sends this information to/from the speech translation device 502. As discussed previously, the speech translation device 502 includes at least one microphone 504 that captures input signals 506 representing nearby speech of a first user (or wearer if the speech translation device is worn) 508 of the device and at least one other nearby person 510. The speech translation device 502 also includes a wireless communication unit 512 that sends the captured input signals 506 representing speech wirelessly to the communication unit 550 of the nearby computing device 516, and receives language translations 518 from the computing device. The speech translation device 502 also includes at least one loudspeaker 520 that outputs the language translations 518 to the first user/wearer 508 and the at least one other nearby person 510.

In this implementation, the computing device 516 interfaces with the server/computing cloud 546 via the communication capabilities 542, 550. The computing device 516 can determine a geographic location using a GPS 522 on the computing device 516 and provide the location information to the server/computing cloud 546. The server/computing cloud 546 can then use this location information for various purposes, such as, for example, to determine a probable language of the conversation to be translated.

The computing device 516 can share processing with the server or computing cloud 546 in order to translate the speech captured by the speech translation device. In one implementation the server/computing cloud 546 can run a speech recognizer 524 for both of the two languages of a conversation. The speech recognizer 524 scores the input speech for the likelihood that it represents a given language and passes the input speech with the highest score/probability of being the given language to a translator 526 for translation into another language (or more languages if desired). In one implementation, the translator 526 translates the input speech in a given first language into a second language. In one implementation, the translator 526 generates a text translation or a transcript 528 of the input speech. The translated text/transcript 528 is converted to an output speech signal 518 that is sent from the server/computing cloud 546 to the computing device 516 over a network 548. The computing device 516 forwards the translated speech 518 to the speech translation device 502 where the translated speech 518 is output by using a text-to-speech converter 530 that may reside on the server/computing cloud 546 or the computing device 516. The translated speech 518 is output by the loudspeaker 520 so that both the first user/wearer 508 and at least another nearby person 510 can hear the translated speech.

In one implementation the translated text/transcript 528 is sent from the server/computing cloud 546 to the computing device 516 and displayed on a display 544 of the computing device 516 or the display of a different device (not shown). In one implementation the translated text/transcript 528 is displayed at the same time the speech signal in the second language is output by the loudspeaker 520.

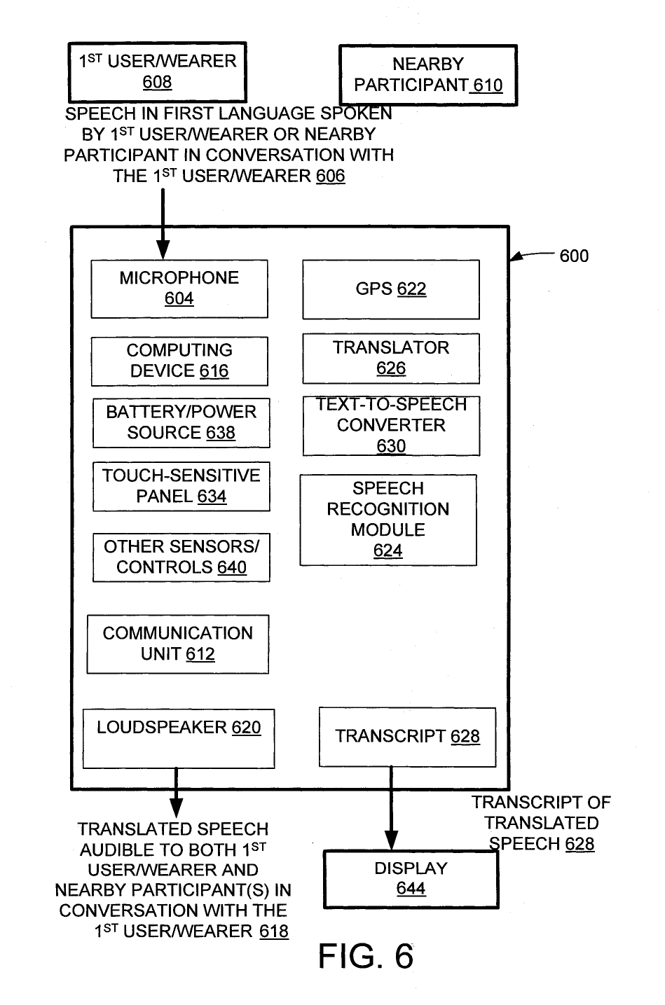

FIG. 6 depicts yet another exemplary wearable personal translator 600. As shown in FIG. 6, this personal translator 600 incorporates a computing device 616 (such as one that will be described in greater detail with respect to FIG. 8). The personal translator 600 includes at least one microphone 604 that captures input signals 606 representing nearby speech of a first user (or wearer) 608 of the device and at least one other nearby person 610. The personal translator 600 also includes a loudspeaker 620 that outputs language translations 618 to the first user/wearer 608 and the at least one other nearby person 610. The personal translator 600 can further include a power source 638, a touch-sensitive panel 634 and other sensors, actuators and controls 640.

The personal translator 600 can determine its geographic location of and use this location information to determine at least one language of the conversation to be translated. For example, the personal translator 600 can have a Global Positioning System (GPS) 622 that allows it to determine its location and use the determined location to infer one or both of the languages to be translated. Alternately, or in addition, the personal translator 600 can have some other method of determining location (not shown).

The personal translator 600 runs a speech recognizer 624 for both of the two languages of the conversation. The speech recognizer 624 attempts to recognize the speech in both languages of the conversation at the same time and passes the recognition result with the highest score to a speech translator 626 for translation into the opposing language.

The translator 626 translates the input speech into the opposing language as discussed previously and generates a text translation (e.g., a transcript 628). The text translation/transcript 628 is converted to an output speech signal by using a text-to-speech converter 630. The translated speech 618 is output by the loudspeaker 620 so that both the first user/wearer 608 and the at least another nearby person 610 can hear the translated speech 618.

In one implementation the translated text/transcript 628 of the input speech is displayed on a display 644 (or some other display (not shown)). In one implementation the translated text/transcript 628 is displayed at the same time the translated speech 618 is output by the loudspeaker 620. This implementation is particularly beneficial for the hard of hearing or deaf participants in the conversation because they can read the transcript and participate in the conversation even if they cannot hear the speech output through the loudspeaker.

In some implementations, as discussed above, the personal translator 600 is always on and can be activated by a voice command or a touch command using a touch-sensitive panel 634. In these implementations the touch command can be received by a touch sensitive panel 634 on the device itself. However, many other ways can be used to activate the device, such as, for example, by a simple switch, by a specific gesture of the wearer, by voice command, by shaking the device or gripping it in a certain pre-defined manner, and so forth, depending on what other sensors 636 the device is configured with.

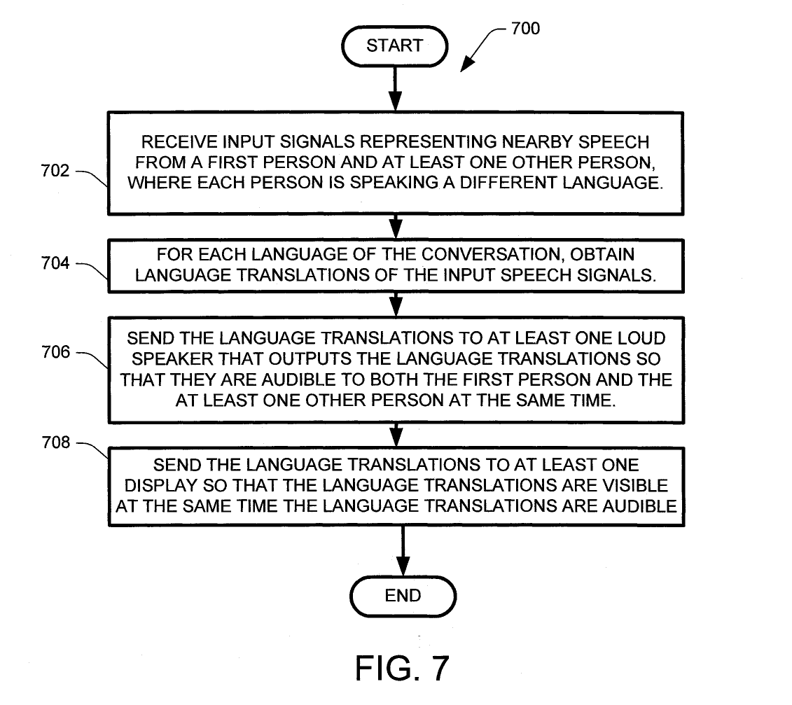

FIG. 7 depicts an exemplary process 700 for practicing various personal translator implementations. As shown in FIG. 7, block 702, input signals representing the nearby speech from a first person and at least one other person, where each person is speaking a different language, are received. For each language of the conversation, language translations of the input speech signals are obtained, as shown in block 704. The language translations are sent to at least one loudspeaker that outputs the language translations so that the language translations are audible to both the first person and the at least one other person at the same time, as shown in block 706. As shown in block 708, the language translations in text format are also sent to at least one display so that the language translations are visible at the same time as the language translations are audible to both the first person and the at least one other person via the at least one loudspeaker.

1.3 Exemplary Working Implementation.

In one working implementation, the personal translator is a custom Bluetooth capable device. It consists of an internal microphone or microphone array, a loudspeaker with a resonating chamber, a touch sensitive panel so that it can be activated via touch, a rechargeable battery to supply power, and a micro-USB connector for recharging. The device pairs with a computing device, such as a phone or computer, which is equipped custom software that is designed to process bilingual conversations.

The custom software can use various translation models. The input signal that the personal translator receives from the computing device is run through speech recognition software for both languages in a conversation. The speech recognition output that scores the highest probability of being a particular language is then passed to a speech translator for translation into the opposing language. The translation generates a transcript that is then converted to speech using text-to-speech software. The speech is then output by the device using the transcript. For the opposing language, the same process is run. In this manner uses can engage in fully bilingual conversations through the device.

### 2.0 Other Implementations

What has been described above includes example implementations. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of detailed description of the recommendation request implementation described above.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the foregoing implementations include a system as well as a computer-readable storage media having computer-executable instructions for performing the acts and/or events of the various methods of the claimed subject matter.

There are multiple ways of realizing the foregoing implementations (such as an appropriate application programming interface (API), tool kit, driver code, operating system, control, standalone or downloadable software object, or the like), which enable applications and services to use the implementations described herein. The claimed subject matter contemplates this use from the standpoint of an API (or other software object), as well as from the standpoint of a software or hardware object that operates according to the implementations set forth herein. Thus, various implementations described herein may have aspects that are wholly in hardware, or partly in hardware and partly in software, or wholly in software.

The aforementioned systems have been described with respect to interaction between several components. It will be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (e.g., hierarchical components).

Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

The following paragraphs summarize various examples of implementations which may be claimed in the present document. However, it should be understood that the implementations summarized below are not intended to limit the subject matter which may be claimed in view of the foregoing descriptions. Further, any or all of the implementations summarized below may be claimed in any desired combination with some or all of the implementations described throughout the foregoing description and any implementations illustrated in one or more of the figures, and any other implementations described below. In addition, it should be noted that the following implementations are intended to be understood in view of the foregoing description and figures described throughout this document.

Various personal translator implementations are by means, systems processes for translating in-person conversations.

As a first example, various personal translator implementations comprise a personal translator with a computing device that receives from a nearby wearable speech translation device input signals representing speech of a first user of the nearby wearable speech translation device and at least one other nearby person in a conversation in two languages. For at least one language in the conversation the computing device of the personal translator automatically creates translated speech of the input speech signals in the one language into the other language of the conversation, and sends the translated speech to the nearby wearable speech translation device for output.

As a second example, in various implementations, the first example is further modified via means, processes or techniques such that the nearby wearable speech translation device comprises at least one microphone that captures the input signals representing nearby speech of the first user and the at least one other nearby person in the conversation; a wireless communication unit that wirelessly sends the captured input signals representing speech to the computing device, and wirelessly receives the translated speech from the computing device; and at least one loudspeaker for outputting the translated speech to the first user and the at least one other nearby person.

As a third example, in various implementations, any of the first example and the second example are further modified via means, processes or techniques such that the wearable speech translation device or the computing device determines a geographic location of the computing device and uses the geographic location to determine at least one language of the conversation.

As a fourth example, in various implementations, the first, second or third example is further modified via means, processes or techniques such that the computing device accesses a computing cloud that provides speech recognition for both of the two languages of the conversation.

As a fifth example, in various implementations, any of the first example, the second example, the third example, and the fourth example are further modified via means, processes or techniques such that the computing device runs a translator to translate between the two languages of the conversation.

As a sixth example, in various implementations, any of the first example, the second example, the third example, the fourth example, and the fifth example are further modified via means, processes or techniques such that the computing device accesses a computing cloud for translation between the two languages of the conversation.

As a seventh example, in various implementations, any of the first example, the second example, the third example, the fourth example, and the fifth example are further modified via means, processes or techniques such that the computing device runs a speech recognizer for both of the two languages of the conversation.

As an eighth example, in various implementations, any of the first example, the second example, the third example, the fourth example, the fifth example, the sixth example and the seventh example is further modified via means, processes or techniques such that a speech recognizer attempts to recognize the input speech signals in both languages of the conversation at the same time and passes a recognition result with a highest score to a translator for translation into a different language from the input speech signals.

As a ninth example, in various implementations, any of the first example, second example, third example, fourth example, fifth example, sixth example, seventh example and eighth example are further modified via means, processes or techniques such that a text translation of the input speech is generated.

As a tenth example, in various implementations, any of the first example, the second example, the third example, the fourth example, the fifth example, the sixth example, the seventh example, the eighth example and the ninth example are further modified via means, processes or techniques such that a text translation of speech is converted to translated speech by using a text-to-speech converter.

As an eleventh example, in various implementations, any of the first example, the second example, the third example, the fourth example, the fifth example, the sixth example, the seventh example, the eighth example, the ninth example and the tenth example are further modified via means, processes or techniques such that translated speech is output by at least one loudspeaker.

As a twelfth example, in various implementations, any of the first example, the second example, the third example, the fourth example, the fifth example, the sixth example, the seventh example, the eighth example and the ninth example, the tenth example and the eleventh example are further modified via means, processes or techniques such that a text translation of the input speech is displayed on a display at the same time translated speech is output by at least one loudspeaker.

As a thirteenth example, in various implementations, any of the first example, the second example, the third example, the fourth example, the fifth example, the sixth example, the seventh example, the eighth example and the ninth example, the tenth example, the eleventh example and the twelfth example are further modified via means, processes or techniques such that a the computing device detects the language being spoken by determining the geographic location of the computing device and using a lookup table of probabilities of language for different regions of the world.

As a fourteenth example, in various implementations, any of the first example, the second example, the third example, the fourth example, the fifth example, the sixth example, the seventh example, the eighth example and the ninth example, the tenth example, the eleventh example, the twelfth example and the thirteenth example are further modified via means, processes or techniques such that the computing device can translate between more than two participants in a conversation.

As a fifteenth example, in various implementations, any of the first example, the second example, the third example, the fourth example, the fifth example, the sixth example, the seventh example, the eighth example and the ninth example, the tenth example, the eleventh example, the twelfth example, the thirteenth example and the fourteenth example are further modified via means, processes or techniques such that the wearable speech translation device can be paired to a different computing device.

As a sixteenth example, various personal translator implementations comprise a wearable speech translation device for in-person translation that comprises at least one microphone that captures the input signals representing speech of a first user wearing the speech translation device and e at least one other nearby person; a wireless communication unit that sends the captured input signals representing speech to a computing device, and receives the translated speech from the computing device; and at least one loudspeaker for outputting the translated speech to the first user and the at least one other nearby person.

As a seventeenth example, in various implementations, the sixteenth example is further modified via means, processes or techniques such that the wearable speech translation device displays transcripts of the translated speech at the same time the at least one loudspeaker outputs the translated speech to be audible to the first user and the at least one other nearby person.

As an eighteenth example, in various implementations, any of the sixteenth and seventeenth example is further modified via means, processes or techniques such that the speech translation device is a wearable device that is in the form of a necklace, a lapel pin, a wrist band or a badge.

As a nineteenth example, various personal translator implementations comprise a wearable speech translation system for in-person translation that comprises at least one microphone that captures input signals representing the nearby speech from a first person wearing the speech translation device and at least one other person, where each person is speaking a different language; at least one loudspeaker that outputs language translations so that the language translations are audible to both the first person and the at least one other person at the same time; a display that displays the language translations; and a first computing device that, receives the input signals representing speech in at least two languages of a conversation, for each language of the conversation, receives language translations of the input speech signals from a second computing device; sends the language translations to the at least one loudspeaker and the display for output at the same time.

As a twentieth example, various personal translator implementations comprise a process for in-person speech translation that comprises receiving input signals representing the nearby speech from a first person and at least one other person, where each person is speaking a different language; for each language of the conversation, obtaining language translations of the input speech signals; sending the language translations to at least one loudspeaker that outputs the language translations so that are audible to both the first person and the at least one other person at the same time; and sending the language translations to at least one display so that the language translations are visible at the same time as the language translations are audible to both the first person and the at least one other person at the same time.

### 3.0 Exemplary Operating Environment:

The personal translator implementations described herein are operational within numerous types of general purpose or special purpose computing system environments or configurations. FIG. 8 illustrates a simplified example of a general-purpose computer system on which various elements of the personal translator implementations, as described herein, may be implemented. It is noted that any boxes that are represented by broken or dashed lines in the simplified computing device 800 shown in FIG. 8 represent alternate implementations of the simplified computing device. As described below, any or all of these alternate implementations may be used in combination with other alternate implementations that are described throughout this document.

The simplified computing device 800 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to realize the personal translator implementations described herein, the device should have a sufficient computational capability and system memory to enable basic computational operations. In particular, the computational capability of the simplified computing device 800 shown in FIG. 8 is generally illustrated by one or more processing unit(s) 810, and may also include one or more graphics processing units (GPUs) 815, either or both in communication with system memory 820. Note that that the processing unit(s) 810 of the simplified computing device 800 may be specialized microprocessors (such as a digital signal processor (DSP), a very long instruction word (VLIW) processor, a field-programmable gate array (FPGA), or other micro-controller) or can be conventional central processing units (CPUs) having one or more processing cores and that may also include one or more GPU-based cores or other specific-purpose cores in a multi-core processor.

In addition, the simplified computing device 800 may also include other components, such as, for example, a communications interface 830. The simplified computing device 800 may also include one or more conventional computer input devices 840 (e.g., touchscreens, touch-sensitive surfaces, pointing devices, keyboards, audio input devices, voice or speech-based input and control devices, video input devices, haptic input devices, devices for receiving wired or wireless data transmissions, and the like) or any combination of such devices.

Similarly, various interactions with the simplified computing device 800 and with any other component or feature of the recommendation request implementation, including input, output, control, feedback, and response to one or more users or other devices or systems associated with the recommendation request implementation, are enabled by a variety of Natural User Interface (NUI) scenarios. The NUI techniques and scenarios enabled by the recommendation request implementation include, but are not limited to, interface technologies that allow one or more users user to interact with the recommendation request implementation in a “natural” manner, free from artificial constraints imposed by input devices such as mice, keyboards, remote controls, and the like.

Such NUI implementations are enabled by the use of various techniques including, but not limited to, using NUI information derived from user speech or vocalizations captured via microphones or other input devices 840 or system sensors 805. Such NUI implementations are also enabled by the use of various techniques including, but not limited to, information derived from system sensors or other input devices 840 from a user's facial expressions and from the positions, motions, or orientations of a user's hands, fingers, wrists, arms, legs, body, head, eyes, and the like, where such information may be captured using various types of 2D or depth imaging devices such as stereoscopic or time-of-flight camera systems, infrared camera systems, RGB (red, green and blue) camera systems, and the like, or any combination of such devices. Further examples of such NUI implementations include, but are not limited to, NUI information derived from touch and stylus recognition, gesture recognition (both onscreen and adjacent to the screen or display surface), air or contact-based gestures, user touch (on various surfaces, objects or other users), hover-based inputs or actions, and the like. Such NUI implementations may also include, but are not limited to, the use of various predictive machine intelligence processes that evaluate current or past user behaviors, inputs, actions, etc., either alone or in combination with other NUI information, to predict information such as user intentions, desires, and/or goals. Regardless of the type or source of the NUI-based information, such information may then be used to initiate, terminate, or otherwise control or interact with one or more inputs, outputs, actions, or functional features of the personal translator implementations.

However, it should be understood that the aforementioned exemplary NUI scenarios may be further augmented by combining the use of artificial constraints or additional signals with any combination of NUI inputs. Such artificial constraints or additional signals may be imposed or generated by input devices 840 such as mice, keyboards, and remote controls, or by a variety of remote or user worn devices such as accelerometers, electromyography (EMG) sensors for receiving myoelectric signals representative of electrical signals generated by user's muscles, heart-rate monitors, galvanic skin conduction sensors for measuring user perspiration, wearable or remote biosensors for measuring or otherwise sensing user brain activity or electric fields, wearable or remote biosensors for measuring user body temperature changes or differentials, and the like. Any such information derived from these types of artificial constraints or additional signals may be combined with any one or more NUI inputs to initiate, terminate, or otherwise control or interact with one or more inputs, outputs, actions, or functional features of the personal translator implementations.

The simplified computing device 800 may also include other optional components such as one or more conventional computer output devices 850 (e.g., display device(s) 855, audio output devices, video output devices, devices for transmitting wired or wireless data transmissions, and the like). Note that typical communications interfaces 830, input devices 840, output devices 850, and storage devices 860 for general-purpose computers are well known to those skilled in the art, and will not be described in detail herein.

The simplified computing device 800 shown in FIG. 8 may also include a variety of computer-readable media. Computer-readable media can be any available media that can be accessed by the computing device 800 via storage devices 860, and include both volatile and nonvolatile media that is either removable 870 and/or non-removable 880, for storage of information such as computer-readable or computer-executable instructions, data structures, program modules, or other data.

Computer-readable media includes computer storage media and communication media. Computer storage media refers to tangible computer-readable or machine-readable media or storage devices such as digital versatile disks (DVDs), blue-ray discs (BD), compact discs (CDs), floppy disks, tape drives, hard drives, optical drives, solid state memory devices, random access memory (RAM), read-only memory (ROM), electrically erasable programmable read-only memory (EEPROM), CD-ROM or other optical disk storage, smart cards, flash memory (e.g., card, stick, and key drive), magnetic cassettes, magnetic tapes, magnetic disk storage, magnetic strips, or other magnetic storage devices. Further, a propagated signal is not included within the scope of computer-readable storage media.

Retention of information such as computer-readable or computer-executable instructions, data structures, program modules, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. Note that the terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, and/or computer program products embodying some or all of the various personal translator implementations described herein, or portions thereof, may be stored, received, transmitted, or read from any desired combination of computer-readable or machine-readable media or storage devices and communication media in the form of computer-executable instructions or other data structures. Additionally, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

The personal translator implementations described herein may be further described in the general context of computer-executable instructions, such as program modules, being executed by a computing device. Generally, program modules include routines, programs, objects, components, data structures, and the like, that perform particular tasks or implement particular abstract data types. The personal translator implementations may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Additionally, the aforementioned instructions may be implemented, in part or in whole, as hardware logic circuits, which may or may not include a processor.

Alternatively, or in addition, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), and so on.

The foregoing description of the personal translator implementations have been presented for the purposes of illustration and description. It is not intended to be exhaustive or to limit the claimed subject matter to the precise form disclosed. Many modifications and variations are possible in light of the above teaching. Further, it should be noted that any or all of the aforementioned alternate implementations may be used in any combination desired to form additional hybrid implementations of the recommendation request implementation. It is intended that the scope of the invention be limited not by this detailed description, but rather by the claims appended hereto. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other equivalent features and acts are intended to be within the scope of the claims.

1. A personal translator, comprising:
a computing device that,
receives from a nearby wearable speech translation device input signals representing speech of a first user of the nearby wearable speech translation device and more than one other nearby person in an in-person conversation in two languages,
for at least one language in the conversation automatically creates translated speech of the input speech signals in the one language into the other language of the conversation, and
sends the translated speech to the nearby wearable speech translation device that outputs the translated speech in both languages via a loudspeaker to the user and the more than one other person so that the user and the more than one other person can simultaneously hear the translated speech in both languages.

2. The personal translator of claim 1, wherein the nearby wearable speech translation device, comprises:
at least one microphone that captures the input signals representing nearby speech of the first user and the at least one other nearby person in the conversation;
a wireless communication unit that wirelessly sends the captured input signals representing speech to the computing device, and wirelessly receives the translated speech from the computing device; and
at least one loudspeaker for outputting the translated speech in both languages to the first user and the at least one other nearby person.

3. The personal translator of claim 2, wherein the wearable speech translation device or the computing device determines a geographic location of the computing device and uses the geographic location to determine at least one language of the conversation.

4. The personal translator of claim 1, wherein the computing device accesses a computing cloud that provides speech recognition for both of the two languages of the conversation.

5. The personal translator of claim 1, wherein the computing device runs a translator to translate between the two languages of the conversation.

6. The personal translator of claim 1, wherein the computing device accesses a computing cloud for translation between the two languages of the conversation.

7. The personal translator of claim 1, wherein the computing device runs a speech recognizer for both of the two languages of the conversation.

8. The personal translator of claim 7, wherein the speech recognizer attempts to recognize the input speech signals in both languages of the conversation at the same time and passes a recognition result with a highest score to a translator for translation into a different language from the input speech signals.

9. The personal translator of claim 8, wherein the translator generates a text translation of the input speech.

10. The personal translator of claim 9, wherein the text translation is converted to the translated speech by using a text-to-speech converter.

11. The personal translator of claim 10 wherein the translated speech is output by the at least one loudspeaker.

12. The personal translator of claim 10, wherein the text translation of the input speech is displayed on a display at the same time the translated speech is output by the at least one loudspeaker.

13. The personal translator of claim 1, wherein the computing device detects the language being spoken by determining the geographic location of the computing device and using a lookup of probabilities of language for different regions of the world.

14. The personal translator of claim 1, wherein the computing device can translate between more than two participants.

15. The personal translator of claim 2, wherein the wearable speech translation device can be paired to a different computing device.

16. A wearable speech translation device for in-person translation, comprising:
at least one microphone that captures the input signals representing speech of a first user wearing the speech translation device and the at least one other nearby person involved in an in-person conversation;
a wireless communication unit that sends the captured input signals representing speech to a computing device, and receives the translated speech from the computing device; and
at least one loudspeaker for outputting the translated speech to the first user and the at least one other nearby person so that the user and the more than one other person can hear the translated speech in both languages.

17. The wearable speech translation device of claim 16 wherein the wearable speech translation device displays transcripts of the translated speech at the same time the at least one loudspeaker outputs the translated speech to be audible to the first user and the at least one other nearby person.

18. The wearable speech translation device of claim 16 wherein the speech translation device is a wearable device is in the form of a necklace, a lapel pin, a wrist band or a badge.

19. A wearable speech translation system for in-person translation, comprising:
at least one microphone that captures input signals representing the nearby speech from a first person wearing the speech translation device and at least one other person involved in an in-person conversation, where each person is speaking a different language;
at least one loudspeaker that outputs language translations so that the language translations in all languages are audible to both the first person and the at least one other person at the same time;
a display that displays the language translations;
a first computing device that,
receives the input signals representing speech in at least two languages of a conversation,
for each language of the conversation, receives language translations of the input speech signals from a second computing device;
sends the language translations to the at least one loudspeaker and the display for output at the same time.

20. A computer-implemented process for in-person speech translation, comprising:
receiving input signals representing the nearby speech from a first person and at least one other person, where each person is speaking a different language in an in-person conversation;
for each language of the conversation, obtaining language translations of the input speech signals;
sending the language translations in each different language to at least one loudspeaker that outputs the language translations so that are audible to both the first person and the at least one other person at the same time;
sending the language translations to at least one display so that the language translations are visible at the same time as the language translations are audible to both the first person and the at least one other person at the same time.
